(19) United States
(12) Patent Application Publication
(10) Pub. No.: US 2004/0064840 A1
(43) Pub. Date: Apr. 1, 2004

(54) Broadcasting method and apparatus using a PDA as a radio signal relay device

(76) Inventor: Huo-Pei Liu, Luchou City (TW)

Correspondence Address: Rabin & Berdo, P.C., Suite 500, 1101 14th Street, Washington, DC, 20005, US

(21) Appl. No.: 10/259,481

(22) Filed: Sep. 30, 2002

(51) Int. Cl. H04N 7/173

(52) U.S. Cl. 725/153; 725/133

(57) ABSTRACT

A broadcasting method using a PDA as a signal relay device has the steps of (a) modulating a sound file intended to be broadcast, wherein the sound file stored in a PDA is modulated in the form of a radio wave at a set frequency, (b) transmitting the modulated radio wave, (c) demodulating and (d) playing the radio wave to obtain the sound file by any radio device. A broadcasting apparatus utilizes a modulating module that is integrated into a charging base of the PDA to modulate sound files stored in the PDA. the modulated sound files can be transmitted in the form of a radio wave and then be demodulated and played by any radio receiving device.

### BACKGROUND OF THE INVENTION

1. Field of Invention

The present invention relates to a broadcasting method and apparatus, and more particularly to a broadcasting method that utilizes a personal digital assistant (PDA) as a radio signal relay device, whereby any radio receiving device, such as a portable radio, is able to be used as the output device for the relayed radio signal.

2. Related Art

Based on the advantages of small size, high capacity, powerful management capabilities, etc., the PDA has been accepted and is utilized by more and more people. To satisfy consumers' requirements, many useful functions, such as wireless access to the Internet, have also been integrated into the PDA.

Although many functions have been integrated into the PDA, the ability to play sounds is still inconvenient and needs to be improved. Now, the PDA can easily download a music file, such as a MP3 file, from an Internet website using a wireless Internet accessing technique or from a computer. Thereafter, a management program stored in the PDA can play the music file. However, when the user wants to listen to the music file, the user must electrically connect an additional music output apparatus, such as earphones or speakers, to the PDA.

However, such use of additional audio output apparatus is inconvenient in particular situations. For example, when the user is driving a car, the use of earphones is inconvenient and may be prohibited.

To overcome the shortcomings, a broadcasting method and apparatus in accordance with the present invention obviates or mitigates the aforementioned drawbacks.

### SUMMARY OF THE INVENTION

The primary objective of the present invention is to provide a broadcasting method and apparatus by means of a PDA as a radio signal relay device, whereby any radio receiving apparatus is able to transmit the relayed radio signal.

To achieve the objective of the present invention, the broadcasting method in accordance with the present invention mainly has the steps of modulating a sound file intended to be broadcast, transmitting the modulated radio wave, demodulating the radio wave to obtain the sound file, and playing the demodulated sound file. The sound file stored in a PDA is modulated in the form of radio waves at a predetermined frequency. The sound file stored in the PDA is obtained from an Internet website, a personal computer, a memory card, etc. The predetermined frequency is set by the PDA. The step of sound file modulating is performed by a modulating module that is integrated into a charging base for the PDA. The step of playing the demodulated sound file is performed by any radio receiving device.

Other objectives, advantages and novel features of the invention will become more apparent from the following detailed description when taken in conjunction with the accompanying drawings.

### BRIEF DESCRIPTION OF THE DRAWINGS

FIG. 1 schematic diagram of equipment needed to implement a broadcasting method in accordance with the present invention; and

FIG. 2 is a functional block diagram of a charging base with a modulating module in accordance with the present invention integrated into the charging base.

### DETAILED DESCRIPTION OF THE INVENTION

A broadcasting method in accordance with the present invention mainly comprises the steps of:

modulating a sound file intended to be broadcast, wherein the sound file stored in a PDA is modulated in the form of radio wave with a predetermined frequency;

transmitting the modulated radio wave;

demodulating the radio wave to obtain the sound file; and

playing the demodulated sound file.

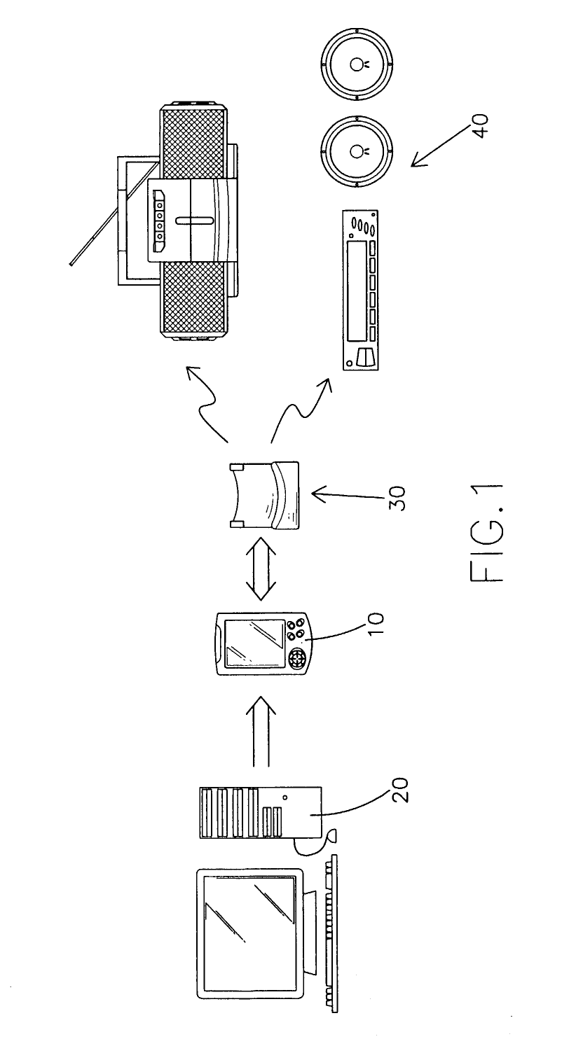

With reference to FIG. 1, as an example, the foregoing steps are performed by a personal digital assistant (PDA)(10), a sound file source (20), a modulating module (30) and any radio receiving device (40). Sound files, such as MP3 files or WAV files, are stored in the personal digital assistant (PDA)(10). The source (20) that provides the sound files can be an Internet website, a personal computer, a memory card, etc. A management software (program) resident in the PDA (10) is used to choose the sound files to be broadcast in the form of a radio signal and to set the frequency of the radio signal.

The modulating module (30) is incorporated into a charging base for the PDA (10) in this embodiment and is electrically connected to the PDA (10) by means of contacts between the charging base and the PDA (10). Since the charging base is an essential device for the PDA (10), no additional hardware is required. The chosen sound files are modulated by the modulating module (30) in the forms of radio signal at the set frequency and then transmitted.

The transmitted radio signal is then demodulated and played by any radio receiving device (40), such as a portable radio, a vehicle radio etc.

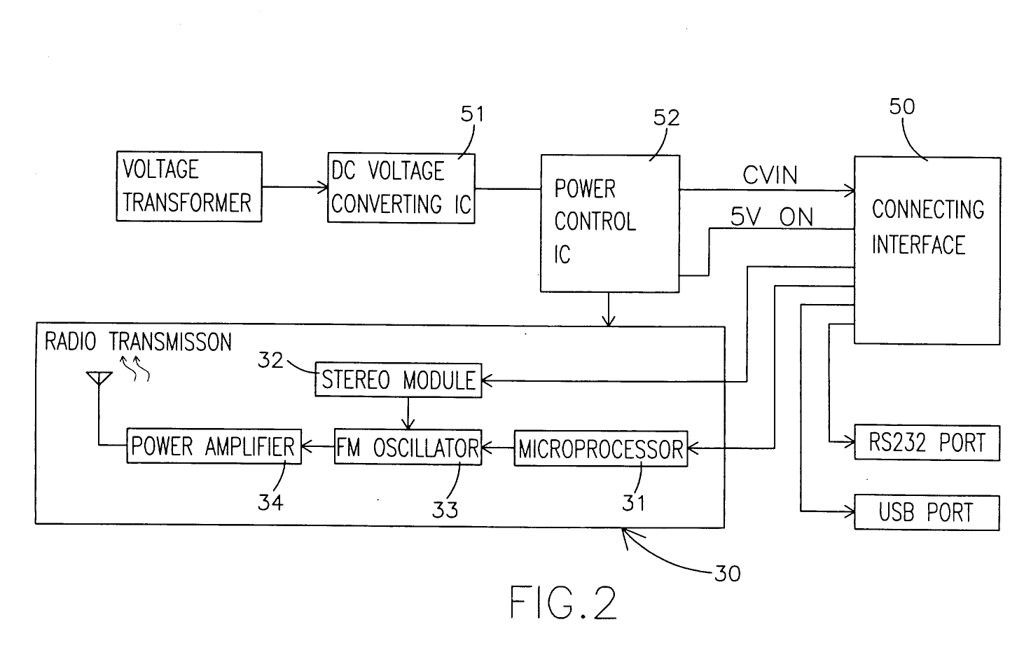

With reference to FIG. 2, the charging base for the PDA (10) mainly comprises a connecting interface (50) and the modulating module (30). The connecting interface (50) provides the electrical connection to the PDA (10) and is connected to a voltage transformer through a power control IC (52) and a DC voltage converting IC (51). After an AC voltage is transformed to a DC voltage by the voltage transformer, the DC voltage converting IC (51) and the power control IC (52) adjust the DC voltage to a specific voltage level to charge the PDA (10).

The modulating module (30) comprises a microprocessor (31), a stereo module (32), a frequency modulation (FM) oscillator (33) and a power amplifier (34). The microprocessor (31) is connected between the connecting interface (50) and the FM oscillator (33) controls the FM oscillator (33) to generate the radio wave at the determined frequency. Moreover, after the sound files are received and processed by the stereo module (32) to improve the sound quality, the sound files are then input to the FM oscillator (33) and combined with the radio wave. The radio wave containing the sound file is further amplified by the power amplifier (34) and then transmitted.

Any sound file stored in the PDA can be broadcast to any radio receiving device when the broadcasting method in accordance with the present invention is adopted. Therefore, the audio output device does not have to be connected physically to the PDA anymore. For example, when a driver uses the PDA and the charging base to broadcast the music files stored in the PDA, the vehicle radio can be used to play the music since the vehicle radio is the most convenient music playing device in this situation.

The invention may be varied in many ways by a skilled person in the art. Such variations are not to be regarded as a departure from the spirit and scope of the invention, and all such modifications are intended to be included within the scope of the following claims.

What is claimed is:

1. A broadcasting method using a PDA as a radio relay device, the method comprising the steps of:
setting a modulation frequency by the PDA;
modulating a sound file stored in a PDA and intended to be broadcast, wherein the sound file is modulated in the form of radio wave at the set frequency;
transmitting the modulated radio wave;
demodulating the radio wave to obtain the sound file; and
playing the demodulated sound file.

2. The broadcasting method as claimed in claim 1, wherein the sound file stored in the PDA is downloaded from any of an Internet website, a computer or a memory card.

3. The broadcasting method as claimed in claim 1, wherein the sound file modulating step is performed by a modulating module that is integrated into a charging base of the PDA.

4. The broadcasting method as claimed in claim 1, wherein the playing the demodulated sound file step is performed by any radio receiving device.

5. The broadcasting method as claimed in claim 4, wherein the radio receiving device is a vehicle radio.

6. The broadcasting method as claimed in claim 4, wherein the radio receiving device is a portable radio.

7. A broadcasting apparatus using a PDA as a radio relay device, the apparatus comprising:
the PDA with sound files stored in the PDA, wherein management software in the PDA selects the sound file to be broadcast and sets a broadcast frequency; and
a modulating module electrically connected to the PDA to modulate the selected sound file in the form of a radio wave at the set frequency, wherein the radio wave is further transmitted by the modulating module.

8. The broadcasting apparatus as claimed in claim 7, wherein the modulating module is integrated into a charging base for the PDA.

9. The broadcasting apparatus as claimed in claim 7, wherein the modulating module comprises:
a microprocessor receiving the set frequency value from the PDA;
a stereo module receiving the selected sound file from the PDA to improve the sound quality; and
a frequency modulation (FM) oscillator receiving the sound file from the stereo module, wherein the FM oscillator is controlled by the microprocessor to generate the radio wave with the set frequency value, wherein the radio wave is further amplified by an power amplifier and then transmitted.

10. The broadcasting apparatus as claimed in claim 8, wherein the modulating module comprises:
a microprocessor receiving the set frequency value from the PDA;
a stereo module receiving the selected sound files from the PDA to improve the sound quality; and
a frequency modulation (FM) oscillator receiving the sound files from the stereo module, wherein the FM oscillator is controlled by the microprocessor to generate the radio wave with the set frequency value, wherein the radio wave is further amplified by an power amplifier and then transmitted.

11. The broadcasting apparatus as claimed in claim 7 further comprising a radio receiving device to demodulate the transmitted radio wave from the modulating device and to play the sound files.

12. The broadcasting apparatus as claimed in claim 8 further comprising a radio receiving device to demodulate the transmitted radio wave from the modulating device and to play the sound files.

13. The broadcasting apparatus as claimed in claim 11, wherein the radio receiving device is a portable radio.

14. The broadcasting apparatus as claimed in claim 12, wherein the radio receiving device is a portable radio.

15. The broadcasting apparatus as claimed in claim 11, wherein the radio receiving device is a vehicle radio.

16. The broadcasting apparatus as claimed in claim 12, wherein the radio receiving device is a vehicle radio.
